(19) United States
(12) Patent Application Publication
(10) Pub. No.: US 2008/0313854 A1
(43) Pub. Date: Dec. 25, 2008

(54) Transport Roller for a Transfer Car

(76) Inventors: Horst Sonnendorfer, Puchheim (DE); Franz Wieth, Puchheim (DE)

Correspondence Address: LERNER GREENBERG STEMER LLP, P O BOX 2480, HOLLYWOOD, FL, 33022-2480, US

(21) Appl. No.: 12/095,847

(22) PCT Filed: Nov. 29, 2006
(86) PCT No.: PCT/DE2006/002115

§ 371 Date: Aug. 15, 2008

(30) Foreign Application Priority Data
Dec. 1, 2005 (DE) 20 2005 018 857.3

(51) Int. Cl. B60B 33/00

(52) U.S. Cl. 16/18 R

(57) ABSTRACT

The invention relates to a transport roller 6 for a transfer car, the roller being linked to a bracket and said bracket being rigidly or steerably mounted on the frame of the transfer car. Portions of the bracket (4) and/or the fastening elements (5) are provided with an electrically insulating coating and/or cleading.

### TECHNICAL FIELD

The invention relates to a transport roller for a transfer car.

### PRIOR ART

In known transport rollers, electrostatic charging of the roller may occur, depending on the material of the carriageway and of the roller, as a result of the roller rolling on the carriageway.

This disadvantageously results in the electrostatic charge of the roller being transmitted to the transfer car.

The longer the distance traveled by the roller on the carriageway, the higher is the charge of the transfer car.

One disadvantage of this is that a person who touches a conductive part of the transfer car in turn receives an uncomfortable electric shock.

From the prior art disclosed in DE 3626954 C1, it is known to add an electrically conductive component to the material for the castor. One disadvantage of the solution is the necessary use of special material for the rollers together with the increased costs of production, and it is also disadvantageous that existing transport rollers can be retrofitted only by complicated replacement of the entire castor.

DE 3913720 C2 discloses an apparatus which is mounted on electrically conductive parts of the transfer car and is electrically connected to the castor by means of a sliding contact. One disadvantage of this solution is the susceptibility to soiling which can get between the contact and the castor. The solution is not suitable for retrofitting the transport rollers either since a great deal of effort is required to provide the bearing for the sliding-contact on the transfer car.

### DISCLOSURE OF THE INVENTION

### Technical Object

The object of the invention is to provide a transport roller in which electrostatic charging is prevented or is reduced to such an extent that no uncomfortable electric shocks take place, this apparatus not being sensitive to soiling and requiring little effort in terms of production and retrofitting of existing transport rollers being easily possible.

### Technical Solution

In the known transport rollers, charging of the castor is prevented by the castor being electrically conductive in its entirety or an electrically conductive material making sliding contact on the surface of the castor.

In a transport roller comprising a plastic castor which is mounted on shaft, the shaft in turn being connected to the transfer car by means of a fork, it has been found as part of a successful solution to the object that an insulator which is arranged in the region between the wheel and the fork largely or completely prevents charging of the transfer car.

### ADVANTAGEOUS EFFECTS

The described measure advantageously prevents an electrostatic charge being transmitted from the wheel to the shopping trolley.

This advantageously results in a person who touches a conductive part of the transfer car now not in turn receiving an uncomfortable electric shock.

### BRIEF DESCRIPTION OF THE DRAWINGS

FIG. 1 shows, as viewed from the front, a roller 1 which rolls on a carriageway 2. The roller 1 is attached to a fork 4 by means of a shaft 3.

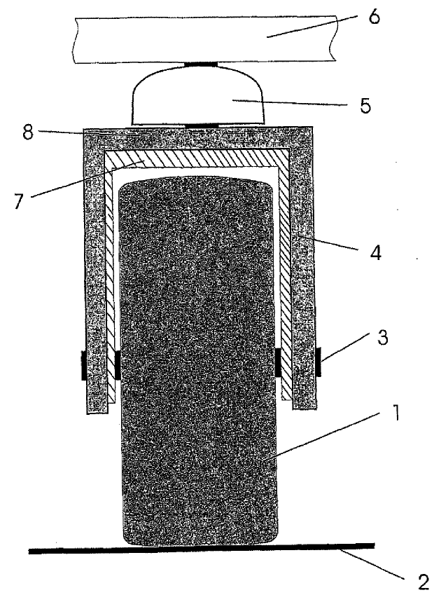

The fork 4 is steerably attached to the frame 6 of a shopping trolley by means of a steering axle 5.

It is equally possible for the roller to be a non-steerable roller in which the fork is rigidly connected to the frame of the shopping trolley.

For reasons of clarity, the shopping trolley is not illustrated in its entirety. The shown part 6 is representative of the shopping trolley.

The inside of the fork 4 is clad with an insulator 7.

The insulator 7 also lines the parts of the steering axle 5 which project into the fork 4.

In many cases, it is also sufficient when only those parts of the steering axle 5 which extend into the fork are covered by an insulator.

In other cases, it is sufficient when that region 8 of the fork 4 which runs parallel to the shaft 3 and faces the wheel 1 is provided with an insulating coating or sheathing.

This insulator prevents the electrostatic charge being transmitted from the roller to other parts.

As an alternative to the illustrated example, it is also possible to sheath, to coat or to paint the entire fork 4 with an insulator.

One advantageous way of sheathing provides for the fork 4 to be provided with a rubber covering. A rubber covering of this type may be applied, for example, in an immersion bath and is an advantageous method on account of the relatively great material thickness remaining as a result.

Applying the insulator 7 or the above-described painting, coating or sheathing advantageously prevents an electrical charge which is produced at the roller 1 being transmitted to the shopping trolley.

### INDUSTRIAL APPLICABILITY

The invention is industrially applicable in any type of roller for the field of application of transfer cars.

1-6. (canceled)

7. A transport roller for transfer cars, with the roller being connected to a retaining fork by means of a shaft, and the retaining fork being fixedly or steerably fitted to the frame of the transfer car by means of attachment elements, characterized in that parts of the retaining fork and/or of the attachment elements are provided with an electrically insulating coating and/or sheathing.

8. The transport roller as claimed in claim 7, characterized in that all parts of the retaining fork are provided with an electrically insulating coating and/or sheathing.

9. The transport roller as claimed in claim 7, characterized in that at least those regions of the retaining fork which face the roller are provided with an electrically insulating coating and/or sheathing.

10. The transport roller as claimed in claim 7, characterized in that at least that region of the retaining fork which runs parallel to the shaft and faces the wheel is provided with an electrically insulating coating and/or sheathing.

11. The transport roller as claimed in claim 7, characterized in that the insulating coating is an additional part which can be retrofitted.

12. The transport roller as claimed in claim 7, characterized in that the insulating sheathing can be applied to the retaining fork by painting, coating or using an immersion bath.
